(19) United States
(12) Patent Application Publication
(10) Pub. No.: US 2007/0121058 A1
(43) Pub. Date: May 31, 2007

(54) Spectable far-sight lens

(75) Inventor: Chin-Fu Chuang, Tainan (TW)

Correspondence Address: Chin-Fu CHUANG, P.O. Box 6-9 717, Tainan, TW

(73) Assignee: JIHN MEI OPTICAL CO., LTD

(21) Appl. No.: 11/287,110

(22) Filed: Nov. 28, 2005

(51) Int. Cl. G02C 7/06

(52) U.S. Cl. 351/54

(57) ABSTRACT

A spectacle far-sight lens has a flexible property gotten from its material, silica gel, and having a sucking surface formed on an inner surface or an outer surface. Then the far-sight lens can be temporarily attached on an outer surface or an inner surface of a lower section of a lens of a pair of conventional eye-protective spectacles or sunglasses by pressed and sucking thereon when a person needs it for seeing things near and takes it down if the person does not use it.

### BACKGROUND OF THE INVENTION

1. Field of the Invention

This invention relates to a spectacle far-sight lens, particularly to one usable temporarily by attaching on a lens of a pair of conventional eye-protective spectacles or sunglasses by pressed and sucking on an outer surface or an inner surface of a lens of conventional eye-protective spectacles or sunglasses when a person needs to use it.

2. Description of the Prior Art

A variety of spectacles are available on the market, including those for the near-sighted, the far-sighted, for protecting eyes from sunlight, and for protecting eyes from being hurt. And many people may get far-sight when they become older, impossible to see things near clearly and needing a pair of far-sight spectacles. Therefore, a conventional far-sight glasses shown in FIGS. 1 and 2 have been in use, with two far-sight lenses 11 formed integral with the eye-protective lenses 1, but far-sight lenses 11 cannot be formed with sunglasses.

### SUMMARY OF THE INVENTION

This invention has been devised to offer a spectacle far-sight lens, particularly attachable to and removable from a lens of any glasses, very convenient to use.

The far-sight lens in the invention is made of silica gel, which has a property of flexibility and sucking, enabling it to be temporarily attached on an outer surface or an inner surface of a lower section of a lens of any spectacles when a person needs to use it.

### BRIEF DESCRIPTION FO DRAWINGS

This invention will be better understood by referring to the accompanying drawings, wherein;

FIG. 1 is a perspective view of a pair of conventional spectacles with far-sight lenses;

FIG. 2 is a cross-sectional view of a far-sight lens of the conventional spectacles;

FIG. 3 is a perspective view of spectacle far-sight lenses to be attached on a pair of conventional spectacles in the present invention;

FIG. 4 is a perspective view of the spectacle far-sight lenses in the present invention attached on an inner surface of the lenses of the conventional spectacles;

FIG. 5 is a cross-sectional view of the spectacle far-sight lens in the present invention attached on an inner surface of a lens of the conventional spectacles;

FIG. 6 is a perspective view of the spectacle far-sight lenses in the present invention to be attached on an outer surface of lenses of a pair of conventional spectacles;

FIG. 7 is a perspective view of the spectacle far-sight lenses in the present invention attached on an outer surface of lenses of a pair of conventional spectacles; and,

FIG. 8 is a cross-sectional view of the spectacle far-sight lens in the present invention attached on an outer surface of the lens of a pair of conventional spectacles.

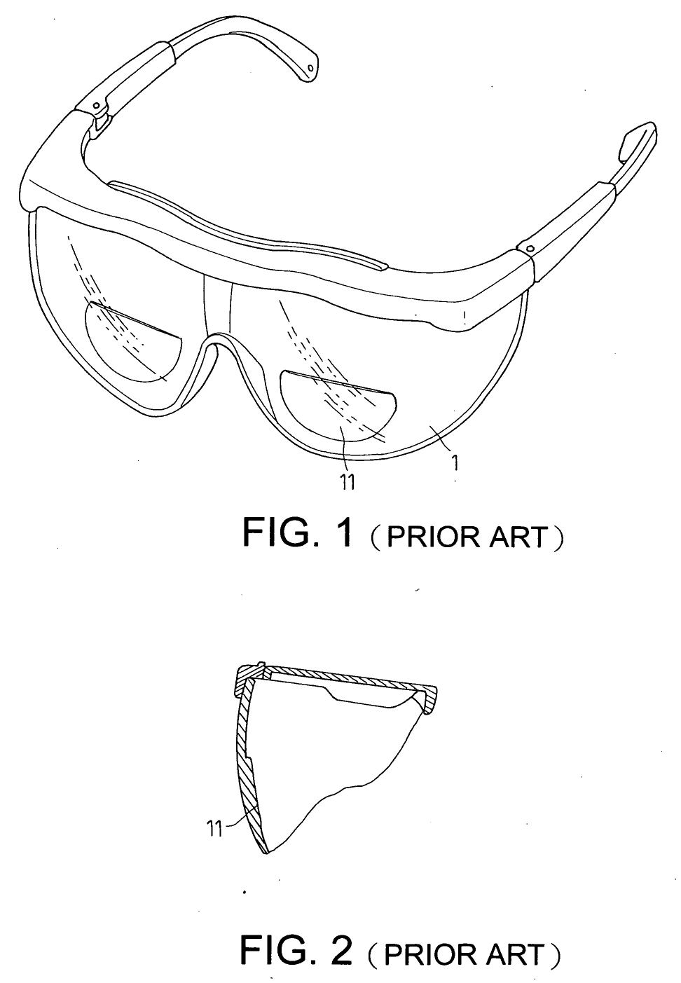

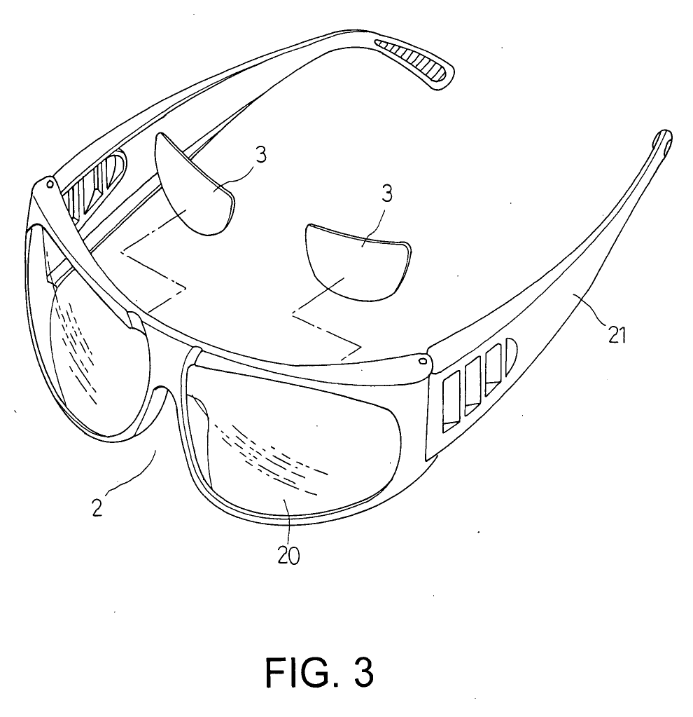

### DETAILED DESCRIPTION OF THE PREFERRED EMODIMENT

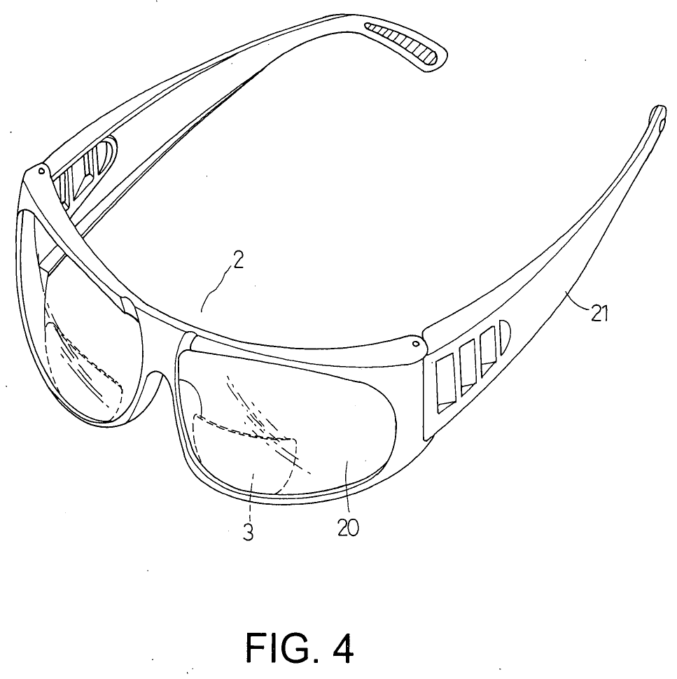

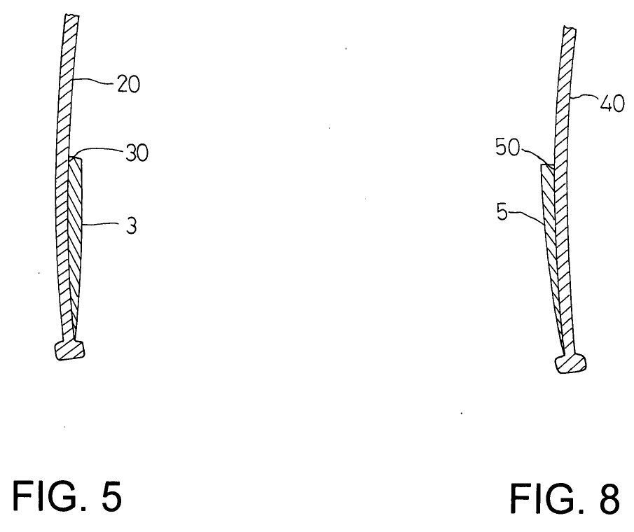

A first preferred embodiment of a spectacle far-sight lens 3 in the present invention, as shown in FIGS. 3, 4 and 5, is made of silica gel, having a flexible property and a sucking surface 30 formed on an outer surface possible to be attached temporarily by pressed and sucking on an inner surface of a lower section of a lens 20 of a pair of conventional eye-protective spectacles or sunglasses 2 when it is needed to be used. Further, the far-sight lens 3 is provided with a proper different far-sighed degree for different persons,

In using, the far-sight lens 3 is placed with its inner surface attached on an outer surface of a lower section of a lens 20 of a pair of conventional eye-protecting spectacles 2 or of sunglasses by pressed with a little force to make it suck on the outer surface of the lower section of the lens 20 so that the far-sight lens 3 may stay there temporarily to see objects near by a user.

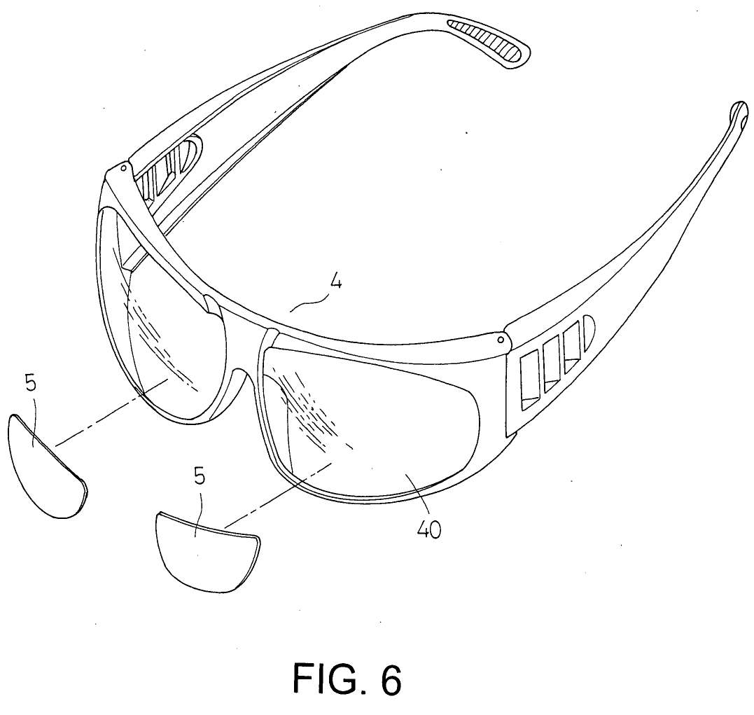

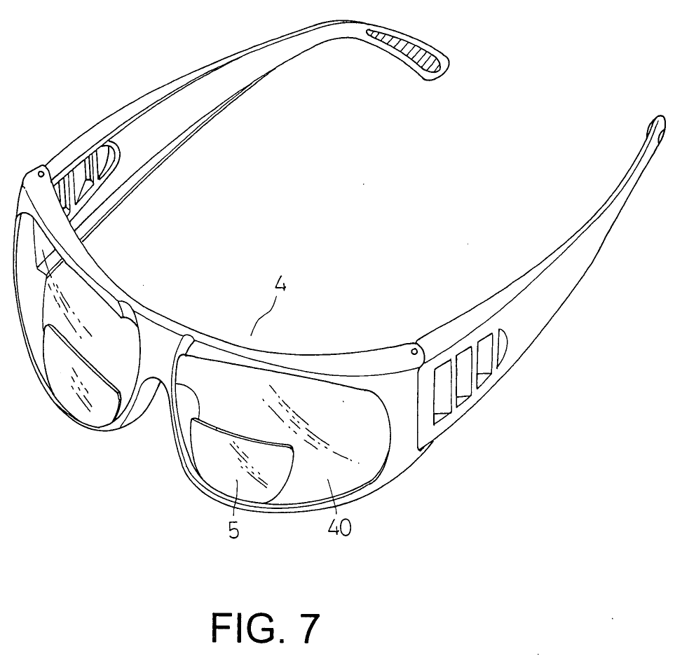

Next, a second embodiment of a spectacle far-sight lens 5 in the invention is shown in FIGS. 6, 7 and 8, also made of silica gel, having a flexible property and a sucking surface 50 formed in an inner surface to enable it to be attached temporarily by pressed and sucking on an outer surface of a lower section of a lens 40 of a pair of conventional eye-protective spectacles 4 or sunglasses.

As to the shape of the far-sight lens 3 or 5, it may be circular, oval or of any shape, and the sucking surface 30 or 50 may be flat or little curved, as the far-sight lens 3 or 5 is flexible owing to its material, silica gel, possible to be pressed to suck on an inner surface or an outer surface of a lens 20 or 40 of a pair of conventional eye-protective spectacles 2 or 4 so that the far-sight lens 3 or 5 may closely suck and stay temporarily on the lens 20 or 40.

The invention has the following advantages, as can be seen from the foresaid description.
1. It can be placed temporarily on the lenses of a pair of conventional eye-protective glasses or sunglasses for use when a person needs to see things near, as it has a flexible sucking function owing to the material, silica gel.
2. The far-sight lens 3 or 5 is made independently from a pair of conventional eye-protective spectacles or sunglasses, very simple to make without any affect to the conventional eye-protective spectacles or sunglasses.
3. As the far-sight lens 3 or 5 is not made integral with a pair of conventional eye-protective spectacles or sunglasses but independently, so if the far-sightedness of a person changes, only the far-sight lens 3 or 5 is needed to be changed, very convenient.
4. The far-sight lens 3 or 5 is independently made, possible to greatly lower its cost.

While the preferred embodiments of the invention have been described above, it will be recognized and understood that various modifications may be made therein and the appended claims are intended to cover all such modifications that may fall within the spirit and scope of the invention.

What is claimed is:

1. A spectacle far-sight lens comprising:
a flexible property gotten from its material, silica gel, formed with a sucking surface on an inner surface so that said far-sight lens may be temporarily attached on an outer surface of a lower section of a lens of a conventional eye-protective spectacles or sunglasses by pressed and sucking thereon when a person needs to use said far-sight lens for seeing things near, and peel it down when the person does not need it.

2. The spectacle far-sight lens as claimed in claim 1, wherein said far-sight lens has a sucking surface formed on an outer side so that said far-sight lens may be temporarily attached on an inner surface of a lower section of a lens of a conventional eye-protective spectacles or sunglasses by pressed and sucking thereon.
